(19) United States
(12) Patent Application Publication
(10) Pub. No.: US 2011/0099297 A1
(43) Pub. Date: Apr. 28, 2011

(54) METHOD AND SYSTEM FOR REMOTELY CONFIGURING A DEVICE ASSOCIATED WITH A LOCAL MACHINE

(76) Inventor: Richard Hayton, Cambridge (GB)

(21) Appl. No.: 12/605,775

(22) Filed: Oct. 26, 2009

(51) Int. Cl. G06F 15/177; G06F 3/00; G06F 9/46; G06F 15/16

(52) U.S. Cl. 710/8; 709/220; 719/327; 709/227

(57) ABSTRACT

A system and method of configuring a USB device connected to a client machine includes detecting, by a local low level device insertion detection system of a client machine, a USB device connected to the client machine by a USB port, the client machine in communication with a remote machine via a remoting protocol; establishing, by the low level device insertion detection system of the client machine, a low-level connection by a USB remoting with a low level device insertion detection system executing in the remote machine; executing, by the remote machine, an application to determine whether to use a driver on the client machine or a driver on the remote machine to configure the device.

### TECHNICAL FIELD

The present disclosure relates to methods and systems for providing access to applications and data on a remote computer over a network. In particular, the present disclosure relates to a method and system for remotely configuring a local device connected to a client machine by a universal serial bus port.

### BACKGROUND OF THE INVENTION

In the emerging Virtual Desktop Infrastructure (VDI) space, a typical user uses an advanced terminal or client machine to connect to a remotely provided computing environment that provide a desktop paradigm. The remote or “virtualized” desktop is typically kept or stored on a remote central server instead of on the hard-drive of the local client machine. Accordingly, the remote desktop may execute a single user operating system (e.g. Windows XP or Windows Vista) or a multi-user operating system (e.g. Windows Server 2003 or 2008), that allows multiple independent connections to separate virtual desktops. In this arrangement, the different users of the independent connections are capable of having different levels of authorization privileges. For example, some user may be permitted access to all, some or none of the applications, files, etc., of the computing environment.

Although client machines are often referred to as ‘dumb terminals’, client machines offer a full desktop experience when connecting in a VDI environment, offering capabilities and performance, specifically designed to best leverage and enhance the performance and functionality of the VDI. For example, client machines are often highly configurable and perform a high degree of local processing (e.g., management of local screen and keyboard, management of locally connected devices, and handling of specific keys and/or key combinations).

Because the VDI provides the perception that the client machine is merely an extension of the remote computer, it is often inconvenient and confusing for a user to configure both the local appliance and the virtual desktop. Moreover, if a new device is attached to the client machine, it is necessary to configure the client machine to recognize and configure the device. A specific example of this is for client machines supporting multiple different means of supporting a device.

One application includes methods and systems for configuring local client machines via a universal serial bus (USB) port. In conventional universal bus remoting systems for enabling USB device communication to be remoted, one of two approaches is used. In a conventional low-level universal bus remoting system, when a USB disk drive is attached to the local appliance, the low level USB bus remoting protocol is used to inform the remote machine. This initiates a device configuration wizard in accordance with the remote operating system. If, for example, the device is recognized as a disk, then the remote machine would install a driver and use the device using the low level USB bus remoting protocol. In a conventional high-level universal bus remoting system when a USB disk drive is attached to the local appliance, the local appliance discovers that a USB disk was attached and configures itself with a local driver. The local appliance will then remote the USB disk using a higher level remote-drive protocol such as, for example, Citrix ICA's Client drive mapping protocol.

Thus, in a conventional low-level universal bus remoting system, a client machine communicates with a server via a remoting protocol. The client machine includes a USB port and a local low-level device insertion detection system configured for detecting a USB device. The server also includes a low level device insertion detection system that is connected to the local low-level device insertion detection system of the client machine via a universal USB bus remoting connection. When the bus remoting connection is established, the server detects a property of the device for determining the type of device, thus establishing (i.e. loading) a driver. A driver, such as, for example, a web cam driver, is then created in the server. Thus a remote session is established for using the inserted device.

In higher level remoting system, the client machine uses a high-level remoting system to communicate with the server. In these systems, when the USB device is inserted into the USB port of the client machine, the low-level device insertion detection system of the client machine determines the type of device that has been inserted and loads a driver accordingly. It then creates a file system driver. Thus a high-level remoting (i.e. file system) is established with the server and the file system is shared between the client machine and the server.

### SUMMARY OF THE INVENTION

The present disclosure is directed to a method and system for remotely configuring a device associated with a local machine via a universal serial bus remoting. In particular, the remote desktop can be used to make configuration changes to a new device attached to a client machine. In one embodiment, a computing environment is described. The computing environment includes a client machine including a local low level device insertion detection system, having device connected thereto by a universal serial bus port; and a remote machine connected to the client machine by a remoting protocol. The remote machine includes an application configured to determine whether the client machine includes a suitable driver to configure the at least one device; and a remote low level device insertion detection system communicating with the local low level device insertion detection system using a universal serial bus remoting connection. The remote low level device insertion detection system communicates with the local low level device insertion detection system using the universal serial bus remoting connection when the application determines that the client machine lacks the suitable driver for configuring the at least one device, and creating a driver to configure the at least one device. In one embodiment, the configured device is used by the remote machine via a high level remoting protocol using the created driver. In another embodiment, the client machine creates the driver to configure the at least one device when the application determines that the client machine includes the suitable driver for configuring the at least one device, and wherein the configured at least one device is used by the remote machine via a high level remoting protocol using the created driver. In one particular embodiment, the remote machine creates the driver to configure the at least one device whether the application determines that the client machine includes a suitable driver. In another embodiment, the application is associated with an operating system executing in the remote machine and wherein the application is executed whenever at least one device is inserted into the universal serial bus port.

A method of configuring a device connected to a client machine is also described. In one embodiment, the method includes detecting, by a local low level device insertion detection system of a client machine, at least one device connected to the client machine by a universal serial bus port, the client machine in communication with a remote machine by a remoting protocol; establishing, by the local low level device insertion detection system of the client machine, a low-level connection, by a universal serial bus remoting, with a low level device insertion detection system executing in the remote machine; executing, by an operating system in the remote machine, a configurable application to determine whether the client machine includes a driver for configuring the at least one device; configuring, by a driver in the client machine, the at least one device when the configurable application determines that the client machine includes a driver for configuring the at least one device; configuring, by a driver in the remote machine, the at least one device when the configurable application determines that the client machine does not include the driver for configuring the at least one device; and applying, by a high level remoting protocol, the configuration of the at least one device to a property of the remote machine and to a property of the client machine. The method further includes establishing, by the remote machine, a low-level connection by a universal serial bus remoting when the client machine does not include the driver for configuring the at least one device. In addition, the remote machine may detect the at least one device for determining at least one property of the at least one device. In one particular embodiment, the method further includes removing the low-level connection between the local low-level device insertion detection systems of the client machine and the remote machine before executing the application. Moreover the application will determine whether to allow the client machine to configure the at least one device, which includes determining whether the client machine includes an adequate driver for configuring the at least one device. The method also includes establishing, by a high level remoting, a remote session using the at least one device.

In another embodiment, a method for remotely configuring a device associated with a local machine, the method includes communicating, by a local low level device insertion detection system, to a remote driver executing in a remote machine that a device is connected to a local machine by a universal serial bus port, where the communication is via a universal serial bus remoting; removing, by the remote machine, the universal serial bus remoting; detecting, by the remote machine, at least one property of the device; determining, by a configurable application executing in the remote machine, whether the local machine includes a driver for configuring the device; configuring, by the local machine, the device when the local machine includes a driver capable of executing the device; configuring, by the remote machine, the device when the local machine does not include a driver capable of executing the device; using the device in a remote session between the local machine and the remote machine, where the remote session is via a high level remoting. The step of determining includes determining whether the client machine includes an adequate driver for configuring the device. The method further includes applying, by an operating system, the configuration of the device to a property of the client machine and a property of the remote machine. The method further includes communicating, by the local machine via a universal serial bus remoting, to the remote machine that the client machine does not include the driver for configuring the device. In one embodiment, the method includes detecting, by the remote machine, the device for determining at least one property of the device. In another embodiment, the method further includes loading a driver or creating a driver by the remote machine for configuring the device.

Other aspects, features and advantages of the presently disclosed systems and methods for configuring a local device via a universal serial bus remoting will become apparent from the following detailed description taken in conjunction with the accompanying drawing, which illustrate, by way of example, the presently disclosed method and system.

### BRIEF DESCRIPTION OF THE DRAWINGS

FIG. 1A is an exemplary block diagram depicting an embodiment of a network environment comprising local machines in communication with remote machines;

FIGS. 1B and 1C are exemplary block diagrams depicting embodiments of a computing device useful in connection with the methods and systems described herein;

FIG. 2 is an exemplary block diagram illustrating one embodiment of a system for driver synchronization between a local appliance and a remote desktop remote machine, in accordance with the present disclosure; and

FIG. 3 is an exemplary flow diagram illustrating one embodiment of a method for driver synchronization between a local appliance and a remote desktop remote machine, in accordance with the present disclosure.

### DETAILED DESCRIPTION

In the following description, numerous specific details are set forth, such as particular components, to provide a thorough understanding of the present invention. However, it will be appreciated by one of ordinary skill in the art that the invention may be practiced without these specific details. In other instances, well-know systems and processing steps have not been described in detail to avoid obscuring the invention.

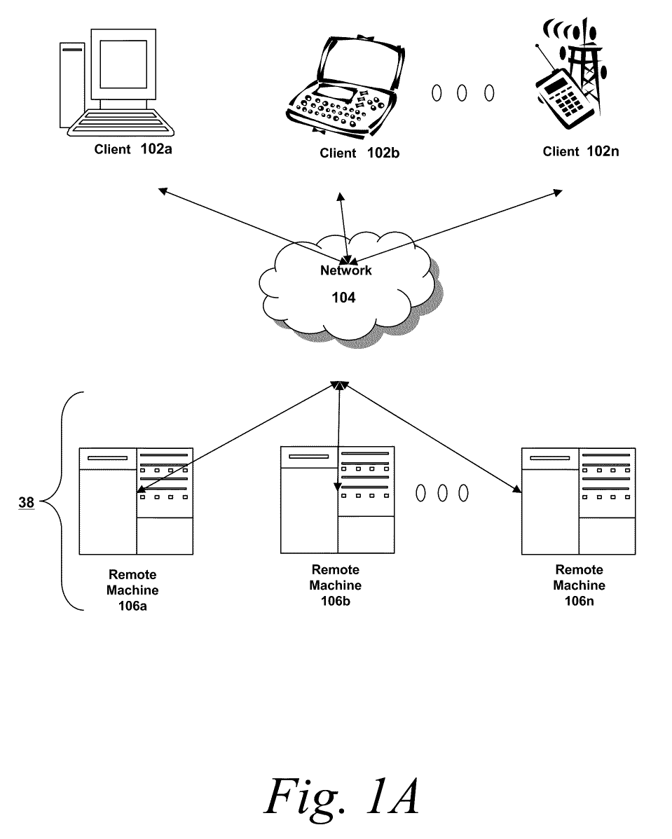

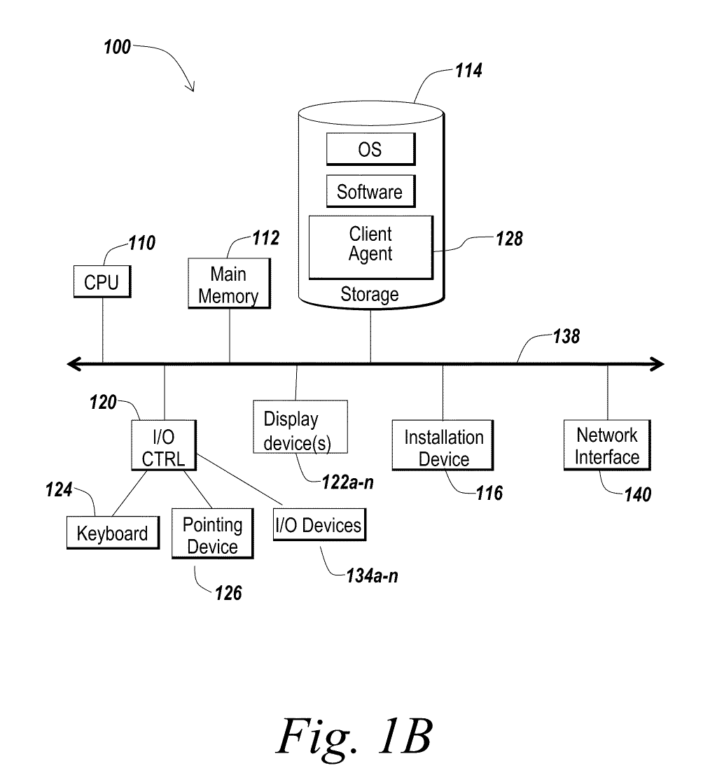

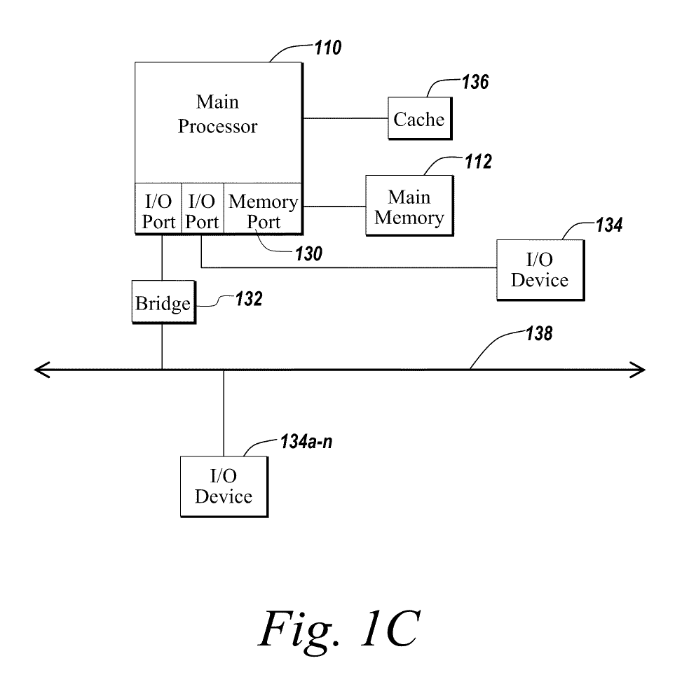

FIG. 1A illustrates an embodiment of a network environment. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106 or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, it is understood that the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In one particular embodiment, different types of data may be transmitted via different protocols. Alternatively, the same types of data may be transmitted via different protocols.

The system described in FIG. 1A may include multiple, logically grouped servers 106. In this particular embodiment, the logical group of servers may be referred to as a server farm 38. Sometimes the servers 106 are geographically dispersed. In other embodiments, a server farm 38 may be administered as a single entity. Alternatively, the server farm 38 comprises a plurality of server farms 38. The servers 106 within each server farm 38 can be heterogeneous—one or more of the servers 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

It is noted that servers 106 of each server farm 38 do not need to be physically proximate to another server 106 in the same server farm 38. Thus, the group of servers 106 logically grouped as a server farm 38 may be interconnected using a wide-area network (WAN) connection or a metropolitan-area network (MAN) connection. For example, a server farm 38 may include servers 106 physically located in different continents or different regions of a continent, country, state, city, campus, or room. Data transmission speeds between servers 106 in the server farm 38 can be increased if the servers 106 are connected using a local-area network (LAN) connection or some form of direct connection.

Remote machine or server 106 may be a file server, application server, web server, proxy server, appliance, network appliance, gateway, application gateway, gateway server, virtualization server, deployment server, SSL VPN server, or firewall. In some embodiments, a server 106 provides a remote authentication dial-in user service, and is referred to as a RADIUS server. In other embodiments, a server 106 may have the capacity to function as either an application server or as a master application server. In still other embodiments, a server 106 is a blade server. In yet other embodiments, a server 106 executes a virtual machine providing, to a user or client computer 102, access to a computing environment.

In one embodiment, a server 106 may include an Active Directory. The server 106 may be an application acceleration appliance. For embodiments in which the server 106 is an application acceleration appliance, the server 106 may provide functionality including firewall functionality, application firewall functionality, or load balancing functionality. In some embodiments, the server 106 comprises an appliance such as one of the line of appliances manufactured by the Citrix Application Networking Group, of San Jose, Calif., or Silver Peak Systems, Inc., of Mountain View, Calif., or of Riverbed Technology, Inc., of San Francisco, Calif., or of F5 Networks, Inc., of Seattle, Wash., or of Juniper Networks, Inc., of Sunnyvale, Calif.

In some embodiments, a server 106 executes an application on behalf of a user of a client 102. In other embodiments, a server 106 executes a virtual machine, which provides an execution session within which applications execute on behalf of a user or a client 102. In one of these embodiments, the execution session is a hosted desktop session. In another of these embodiments, the execution session provides access to a computing environment, which may comprise one or more of: an application, a plurality of applications, a desktop application, and a desktop session in which one or more applications may execute.

In some embodiments, a client 102 communicates with a server 106. In one embodiment, the client 102 communicates directly with one of the servers 106 in a server farm 38. In another embodiment, the client 102 executes a program neighborhood application to communicate with a server 106 in a server farm 38. In still another embodiment, the server 106 provides the functionality of a master node. In some embodiments, the client 102 communicates with the server 106 in the server farm 38 through a network 104. Over the network 104, the client 102 can, for example, request execution of various applications hosted by the servers 106a-106n in the server farm 38 and receive output of the results of the application execution for display. In some embodiments, only the master node provides the functionality required to identify and provide address information associated with a server 106b hosting a requested application.

In one embodiment, the server 106 provides the functionality of a web server. In another embodiment, the server 106a receives requests from the client 102, forwards the requests to a second server 106b and responds to the request by the client 102 with a response to the request from the server 106b. In still another embodiment, the server 106 acquires an enumeration of applications available to the client 102 and address information associated with a server 106′ hosting an application identified by the enumeration of applications. In yet another embodiment, the server 106 presents the response to the request to the client 102 using a web interface. In one embodiment, the client 102 communicates directly with the server 106 to access the identified application. In another embodiment, the client 102 receives output data, such as display data, generated by an execution of the identified application on the server 106.

In some embodiments, the server 106 or a server farm 38 may be running one or more applications, such as an application providing a thin-client computing or remote display presentation application. In one embodiment, the server 106 or server farm 38 executes as an application any portion of the CITRIX ACCESS SUITE by Citrix Systems, Inc., such as the METAFRAME or CITRIX PRESENTATION SERVER and/or any of the MICROSOFT WINDOWS Terminal Services manufactured by the Microsoft Corporation. In another embodiment, the application is an ICA client, developed by Citrix Systems, Inc. of Fort Lauderdale, Fla. In still another embodiment, the server 106 may run an application, which, for example, may be an application server providing email services such as MICROSOFT EXCHANGE manufactured by the Microsoft Corporation of Redmond, Wash., a web or Internet server, or a desktop sharing server, or a collaboration server. In yet another embodiment, any of the applications may comprise any type of hosted service or products, such as GOTOMEETING provided by Citrix Online Division, Inc. of Santa Barbara, Calif., WEBEX provided by WebEx, Inc. of Santa Clara, Calif., or Microsoft Office LIVE MEETING provided by Microsoft Corporation of Redmond, Wash.

A client 102 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on client 102. In some embodiments, the application may be a server-based or a remote-based application executed on behalf of the client 102 on a server 106. In one embodiments the server 106 may display output to the client 102 using any thin-client or remote-display protocol, such as the Independent Computing Architecture (ICA) protocol manufactured by Citrix Systems, Inc. of Ft. Lauderdale, Fla. or the Remote Desktop Protocol (RDP) manufactured by the Microsoft Corporation of Redmond, Wash. The application can use any type of protocol and it can be, for example, an HTTP client, an FTP client, an Oscar client, or a Telnet client. In other embodiments, the application comprises any type of software related to voice over internet protocol (VoIP) communications, such as a soft IP telephone. In further embodiments, the application comprises any application related to real-time data communications, such as applications for streaming video and/or audio.

The client 102 and server 106 may be deployed as and/or executed on any type and form of computing device, such as a computer, network device or appliance capable of communicating on any type and form of network and performing the operations described herein.

FIGS. 1B and 1C depict block diagrams of a computing device 100 useful for practicing an embodiment of the client 102 or a server 106. As shown in FIGS. 1B and 1C, each computing device 100 includes a central processing unit 110 and a main memory unit 112. As shown in FIG. 1B, the computing device 100 may include a storage device 114, an installation device 116, a network interface 140, an I/O controller 120, display devices 122a-n, a keyboard 124 and a pointing device 126, such as a mouse. The storage device 114 may include, without limitation, an operating system, software, and a client agent 128. As shown in FIG. 1C, each computing device 100 may also include additional optional elements, such as a memory port 130, a bridge 132, one or more input/output devices 134a-134n (generally referred to using reference numeral 134), and a cache memory 136 in communication with the central processing unit 110.

The central processing unit 110 is any logic circuitry that responds to and processes instructions fetched from the main memory unit 112. In many embodiments, the central processing unit 110 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 112 may be one or more memory chips capable of storing data and allowing any storage location to be directly accessed by the microprocessor 110, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory unit 112 may be based on any of the above described memory chips, or any other available memory chips capable of operating as described herein. In the embodiment shown in FIG. 1B, the processor 110 communicates with main memory unit 112 via a system bus 138 (described in more detail below). FIG. 1C depicts an embodiment of a computing device 100 in which the processor communicates directly with main memory unit 112 via a memory port 130. For example, in FIG. 1C the main memory 112 may be DRDRAM.

FIG. 1C depicts an embodiment in which the main processor 110 communicates directly with cache memory 136 via a secondary bus, sometimes referred to as a backside bus. In other embodiments, the main processor 110 communicates with cache memory 136 using the system bus 138. Cache memory 136 typically has a faster response time than main memory unit 112 and is typically provided by SRAM, BSRAM, or EDRAM. In the embodiment shown in FIG. 1C, the processor 110 communicates with various I/O devices 130 via a local system bus 138. Various buses may be used to connect the central processing unit 110 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 122, the processor 110 may use an Advanced Graphics Port (AGP) to communicate with the display 122. FIG. 1C depicts an embodiment of a computer 100 in which the main processor 110 communicates directly with I/O device 134b via HYPERTRANSPORT, RAPIDIO, or INFINIBAND communications technology. FIG. 1C also depicts an embodiment in which local busses and direct communication are mixed: the processor 110 communicates with I/O device 134a using a local interconnect bus while communicating with I/O device 134b directly.

A wide variety of I/O devices 134a-134n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 120 as shown in FIG. 1B. The I/O controller may control one or more I/O devices such as a keyboard 124 and a pointing device 126, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the client agent 128. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 140 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 140 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 122a-122n, which each may be of the same or different type and/or form. As such, any of the I/O devices 134a-134n and/or the I/O controller 120 may comprise any type and/or form of suitable hardware, software, or combination of hardware and software to support, enable or provide for the connection and use of multiple display devices 122a-122n by the computing device 100. For example, the computing device 100 may include any type and/or form of video adapter, video card, driver, and/or library to interface, communicate, connect or otherwise use the display devices 122a-122n. In one embodiment, a video adapter may comprise multiple connectors to interface to multiple display devices 122a-122n. In other embodiments, the computing device 100 may include multiple video adapters, with each video adapter connected to one or more of the display devices 122a-122n. In some embodiments, any portion of the operating system of the computing device 100 may be configured for using multiple displays 122a-122n. In other embodiments, one or more of the display devices 122a-122n may be provided by one or more other computing devices, such as computing devices 100a and 100b connected to the computing device 100, for example, via a network. These embodiments may include any type of software designed and constructed to use another computer's display device as a second display device 122a for the computing device 100. One ordinarily skilled in the art will recognize and appreciate the various ways and embodiments that a computing device 100 may be configured to have multiple display devices 122a-122n.

In further embodiments, an I/O device 134 may be a bridge between the system bus 138 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. For example, the computer system 100 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device 100 may have different processors, operating systems, and input devices consistent with the device. For example, in one embodiment, the computing device 100 is a TREO 180, 270, 600, 650, 680, 700p, 700w/wx, 750, 755p, 800w, Centro, or Pro smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, i335, i365, i570, I576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, and the Blackberry Pearl Flip. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Computer of Cupertino, Calif.

In some embodiments, a server 106 executes an application on behalf of a user of a client 102. In other embodiments, a server 106 executes a virtual machine, which provides an execution session within which applications execute on behalf of a user or a client 102. In one of these embodiments, the execution session is a hosted desktop session. In another of these embodiments, the execution session provides access to a computing environment, which may comprise one or more of: an application, a plurality of applications, a desktop application, and a desktop session in which one or more applications may execute. In further embodiments, the server 106 provides access to a hosted desktop session executing on the server 106. In one of these embodiments, the hosted desktop session is not required to execute within a virtual machine.

In some embodiments, a desktop appliance (i.e. a client machine) communicates via a network with a broker service to authenticate a user of the desktop appliance and receive information needed to connect to the remote machine. In some systems, the remote computer provides a user of a client machine with access to a resource, which may include, without limitation, computing environments (including, for example, desktops), applications, documents, files (including user data and user configuration files), and hardware resources. In one of these embodiments, a brokered connection model allows for centralized policy and authorization control, amongst many other benefits. However, when using desktop appliances, a complication may arise if certain tasks, including authentication, require user interaction with the desktop appliance itself prior to connection to the remote desktop; other tasks may require interaction with the remote machine while the desktop appliance is connected to the remote machine, and still other tasks require user interaction with the desktop appliance while it is connected to the remote desktop.

As an example of one of these complications, in some embodiments the broker service is trusted to authenticate all users of the system, but not all desktop hosts are trusted to receive connections from all users of the system. In one of these embodiments, receiving a connection may result in receiving the ability to impersonate the connecting user, usually by means of receiving their explicit credentials. In another of these embodiments, this partial level of trust in desktop hosts is allowed because, in practice, some users will be granted local administrator privileges on the desktop host(s) they normally use, for reasons of application compatibility or user demand for desktop control requiring local administrative rights. In still another of these embodiments, a security policy may require employees not to disclose their credentials to anyone, including other employees, which may result in employees needing certain local administrator privileges. In yet another of these embodiments, many organizations have at least one employee with very high levels of access privileges who should only log on to hosts that are suitably configured (and trusted to be so configured) to not abuse their credentials or privileges or expose them to misuse by others. However, in one of these embodiments, requiring the local user to provide credentials upon local log-on and upon log-on to a remote machine and potentially upon log-on to particular resources provided by the remote machine may confuse the user, may impose an intolerable user interaction burden, or may limit the ability of the desktop appliance to present remotely-executing resources to a user as if the resources were executing locally.

In some embodiments, a method for authenticating a user by a trusted local component allows for local authentication of a user regardless of a type of interaction required by the task. In one of these embodiments, the method includes providing functionality for processing security procedures or requests to access a secure desktop functionality. One such security procedure for accessing a local Windows desktop includes the use of a Secure Attention Sequence (SAS).

In one embodiment, methods and systems are described in which a fully-trusted entity (such as a part of a desktop appliance) processes the Secure Attention Sequence (SAS) and in which other trusted entities (including, for example, a broker service and a remote machine to which the desktop appliance is connected) provide access to and process the associated tasks that are accessible after the entering of the SAS. In another embodiment, this is done in a way that minimizes user confusion, by maintaining the user interactions familiar to users of local WINDOWS desktops. In other embodiments, methods and systems are described to achieve this behavior when the desktop appliance is running a WINDOWS operating system such as WINDOWS XP to leverage existing local operating system components that normally receive and process the SAS without replacing those components.

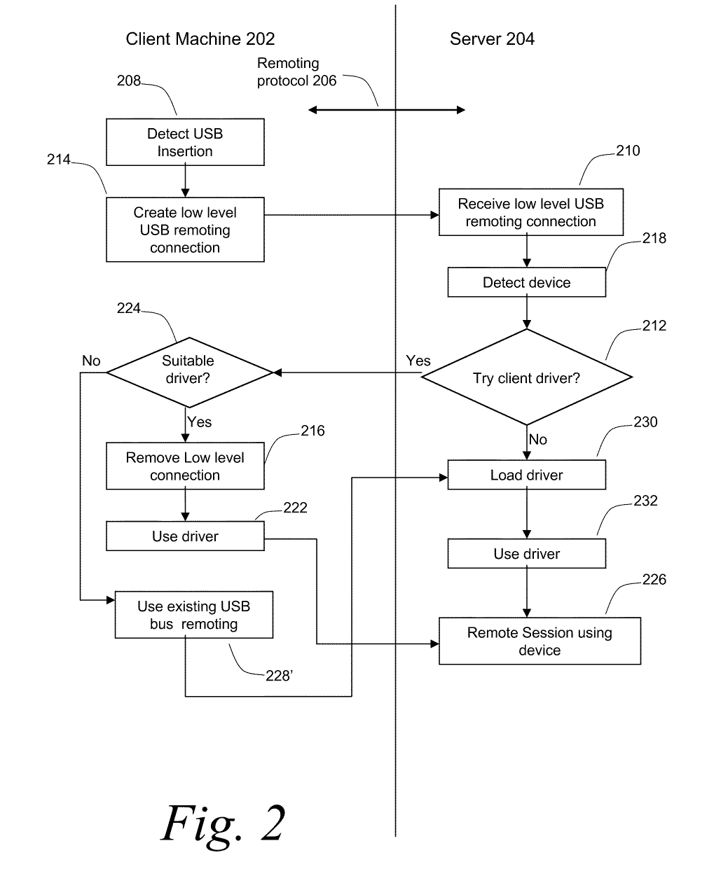

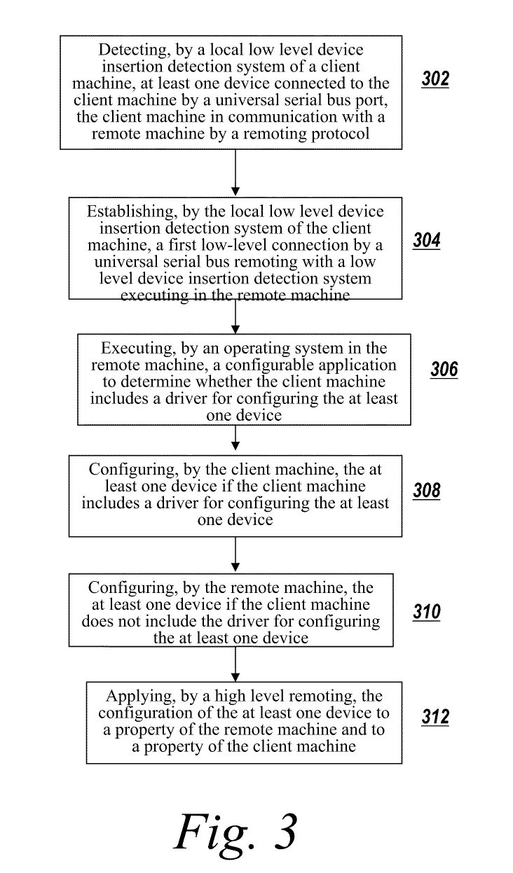

With reference to FIGS. 2 and 3, the present invention provides an improved method and system for synchronizing a client machine and a remote server using universal serial bus (USB) remoting. In particular, a remote server is used to make configuration changes to a device connected to the client machine by the USB remoting.

With particular reference to FIG. 2, and in accordance with one embodiment of the present invention, a computing environment includes a system 200 for remotely configuring at least one USB device connected to a local client machine. System 200 includes a client machine 202 in communications with a remote machine or server 204 via a remoting protocol 206. Client machine 202 includes a universal serial bus (USB) port (not shown) for receiving a USB device (not shown) and a low-level device insertion detection system associated with the USB port and configured for detecting the USB device (208).

Client machine 202 is any device with local computing power, such as, for example, a desktop appliance or client machine 202, as described hereinabove with respect to FIGS. 1A and 1B. In addition, client machine 202 may be a device for providing access to resources provided by remote machines via a presentation layer protocol. In this particular embodiment, the user need not be aware that the machine in use is actually remote. In one particular embodiment, client machine 202 is a multi-function thin client device, capable of facilitating access to a variety of services and resources provided by remote machines, such as, for example, presentation servers, terminal services, and web applications.

In some embodiments, client machine 202 executes a plurality of software components that are part of or registered with the client machine operating system, where the software components are able to communicate with a broker service and a remote desktop host. Alternatively, the software components are able to support direct uncorrupted interaction with the user by means of locally generated user interface screens and protected user input focus. The plurality of software components depend on an operating system executed by client machine 202.

In yet another embodiment, client machine 202 is a machine in which the user has limited or no access to functionality provided by a local operating system. For example, in particular embodiments, client machine 202 is a Devon IT SAFEBOOK manufactured by Devon IT, Inc., of King of Prussia, Pa. Alternatively, the client machine is a Chip PC Plug PC manufactured by Chip PC Technologies of Tirat Carmel, Israel and Irving, Tex., USA. In one particular embodiment, the client machine is an HP Compaq 2533t or 6720 Mobile Thin Client, or an HP Compaq t5135 or t5730, or an HP Compaq t5530 or t5735 Thin Client, manufactured by Hewlett-Packard Company of Palo Alto, Calif. In another embodiment, client machine 202 is an IGEL Compact series appliance manufactured by IGEL Technology, Inc., of Fort Lauderdale, Fla.

Server 204 is a desktop host or remote machine 106 (FIG. 1A). For example, server 204 may be a physical PC located on a corporate network, a physical server (e.g., a blade PC) in a data center, or a virtual machine in a data center.

The USB port associated with client machine 202 is a conventional serial bus standard for connecting devices to a host computer, such as client machine 202. In particular, USB port 208 allows for peripherals or devices to be connected to client machine 202 without rebooting or turning off client machine 202.

With continued reference to FIG. 2, server 204 includes an operating system (not shown), means for receiving the low level USB remoting connection (210) and a configurable application 212 executed by the operating system. When the low-level device insertion detection system 208 of client machine 202 detects a USB device in the USB port, it establishes an initial universal USB bus remoting connection 214 with the means for receiving the low-level device insertion detection system 210 of server 204. After the remoting connection 214 is established, application 212 will execute to determined whether to use a driver on the client machine 202 or a driver on the server 204 to configure the device. If application 212 determines that client machine 202 includes a suitable driver (224) to configure the device, then the client machine 202 will remove (216) the low level remoting connection 214, use the driver (222) and will establish a remote session (226) using the device.

In one embodiment, application 212 determines to use the client machine 204 to configure the device by ascertaining (224) whether the client machine 202 includes a driver 222 that can be used to configure the USB device. In one embodiment, application 212 may be configured to always check the client machine 202 for an adequate driver 222. In another embodiment, application 212 is configured never to try the client machine 202 for a driver and instead permit the server 204 to always configure the USB device. In these embodiments, a policy or configuration is stored in server 204. Server 204 will consult the stored policy to determined which action to take, such as, for example, ‘OnlyAllowClientDevice’, ‘PreferClientDevice’, ‘PreferServerDevice’ and ‘OnlyAllowServerDevice’. The means by which the policy may be expressed include, inter alia, a policy system such as Microsoft Group Policy, Citrix Extended Policy Engine or simple static configuration files.

If application 212 of server 204 selects to use client driver 222 in client machine 202, then the application 212 will communicate with client machine 202, and determine the adequate driver and execute client driver 222. A high-level remoting (226) is established, via client driver 222, between client machine 202 and server 204. A remote session is thus established using USB device. Accordingly, the USB device may be used by both the client machine 202 and by the remote machine or server 204.

If application 212 determines that the client machine 202 does not include an suitable driver 222, then a signal is sent to the low level device insertion detection system (208) of client machine 202 to establish the universal USB bus remoting connection (228) that is received by the low level device insertion detection system 210 of server 204. Server 204 then loads a driver 230 and uses (232) the driver to establish a remote session 226 using the USB device.

In another embodiment, and with continued reference to FIG. 2, if application 212 decides not to try for client driver 222, then server 204 loads a driver (230) and uses (232) the driver to establish a remote session 226 using the USB device.

With reference to FIG. 3, a method of configuring a USB device connected to a client machine 202 via a USB port is described. The method includes, at step 302, detecting, by a local low-level device insertion detection system of a client machine 202, at least one USB device connected to client machine 202 by a universal serial bus port. As described hereinabove, the client machine 202 is in communication with a remote machine 204 via remoting protocol 206. When the USB device is inserted into the USB port, the USB device is detected by the low level device insertion detection system, as described hereinabove, which creates (304) a low level connection by a universal serial bus remoting connection with a low level device insertion detection system 210 executing in remote machine or server 204.

Server 204 includes an operating system, which executes (306) an application 212. The application 212 is configured for determining whether client machine 202 includes a driver 222 for configuring the USB device. If client machine 202 includes an adequate driver 222, then client machine 202 configures (308) the USB device. If the client machine does not include a driver for configuring USB device, then the remote machine 204 configures the device (310). A high level remoting 228 then applies (312) the configuration of the device to a property of the remote machine and to a property of the client machine.

While FIGS. 1-3 illustratively describe exemplary components and devices that can be used to practice the exemplary systems and methods, according to specific embodiments of the present invention, it is clear that a person ordinarily skilled in the art can readily modify the demonstrated computing devices as well as the method steps for adaptation to application requirements consistent with the above descriptions. For example, the above described system and method is readily modifiable to apply to remote connections with characteristics similar to USB, such as, for example, IEEE 1394 interface and Serial-ATA interface. It should therefore be recognized that the present invention is not limited to the specific embodiments illustrated hereinabove, but rather extends in utility to any other modification, variation, application, and embodiment, and accordingly, all such modifications, variations, applications, and embodiments are to be regarded as being within the scope of the invention.

What is claimed is:

1. A computing environment, comprising:
a client machine including a local low level device insertion detection system (LLDID), having at least one device connected thereto by a universal serial bus port; and
a remote machine connected to the client machine by a remoting protocol, the remote machine including:
an application configured to determine whether to use at least one of a driver on the client machine and a driver on the remote machine to configure the at least one device.

2. The computing environment recited in claim 1, wherein the configured at least one device is used by the remote machine via a high level remoting protocol using the created driver.

3. The computing environment recited in claim 1, wherein the client machine creates the driver to configure the at least one device when the application determines to the client machine to configure the at least one device, and wherein the configured at least one device is used by the remote machine via a high level remoting protocol using the created driver.

4. The computing environment recited in claim 1, wherein the remote machine creates the driver to configure the at least one device when the application determines to use the driver on the remote machine.

5. The computing environment recited in claim 1, wherein the application is associated with an operating system executing in the remote machine and wherein the application is executed whenever at least one device is inserted into the universal serial bus port.

6. A method of configuring at least one device connected to a client machine, the method comprising:
detecting, by a local low level device insertion detection system of a client machine, at least one device connected to the client machine by a universal serial bus port, the client machine in communication with a remote machine by a remoting protocol;
establishing, by the local low level device insertion detection system of the client machine, a low-level connection, by a universal serial bus remoting, with a low level device insertion detection system executing in the remote machine; and
executing, by an operating system in the remote machine, a configurable application to determine whether to use at least one of a driver on the client machine and a driver on the remote machine to configure the at least one device.

7. The method recited in claim 6, further comprising configuring, by a driver in the client machine, the at least one device when the configurable application determines that the client machine includes a driver for configuring the at least one device.

8. The method recited in claim 6, further comprising configuring, by the remote machine, the at least one device when the configurable application determines that the client machine lacks the driver for configuring the at least one device.

9. The method recited in claim 6, further comprising applying, by a high level remoting protocol, the configuration of the at least one device to a property of the remote machine and to a property of the client machine.

10. The method recited in claim 6, further comprising detecting, by the remote machine, the at least one device for determining at least one property of the at least one device.

11. The method recited in claim 6, further comprising determining, by the configurable application, whether to permit the client machine to configure the at least one device, the step of determining including determining whether the client machine includes a driver for configuring the at least one device.

12. The method recited in claim 6, further comprising establishing, by a high level remoting, a remote session using the at least one device.

13. A method for remotely configuring a device associated with a local machine, the method comprising:
communicating, by a local low level device insertion detection system, to a remote driver executing in a remote machine that a device is connected to a local machine by a universal serial bus port, wherein the communication is via a universal serial bus remoting;
removing, by the remote machine, the universal serial bus remoting;
detecting, by the remote machine, at least one property of the device;
determining, by a configurable application executing in the remote machine, whether the local machine includes a driver for configuring the device;
configuring, by the local machine, the device when the local machine includes a driver for executing the device;
configuring, by the remote machine, the device when the local machine lacks a driver for executing the device;
using the device in a remote session between the local machine and the remote machine, wherein the remote session is via a high-level remoting.

14. The method of claim 13, further comprising applying, by an operating system, the configuration of the device to a property of the client machine.

15. The method of claim 13, further comprising applying, by an operating system, the configuration of the device to a property of the remote machine.

16. The method of claim 13, further comprising communicating, by the local machine via the universal serial bus remoting, to the remote machine that the client machine lacks the driver for configuring the device.

17. The method recited in claim 13, further comprising detecting, by the remote machine, the device for determining at least one property of the USB device.

18. The method recited in claim 13, further comprising at least one of loading and creating a driver for configuring the device.

19. The method recited in claim 13, wherein the step of determining includes determining whether the client machine includes an adequate driver for configuring the device.

20. The method recited in claim 13, further comprising establishing, by a high level remoting, a remote session using the device.
